(19) United States
(12) Patent Application Publication
(10) Pub. No.: US 2007/0086613 A1
(43) Pub. Date: Apr. 19, 2007

(54) Multi-media loudspeaker capable of receiving and transmitting voice via the internet

(76) Inventors: Wen-Han Chang, Taipei City (TW); Chin-Ming Lu, Taipei City (TW)

Correspondence Address: LEONG C LEI, PMB # 1008, 1867 YGNACIO VALLEY ROAD, WALNUT CREEK, CA, 94598, US

(21) Appl. No.: 11/249,440

(22) Filed: Oct. 14, 2005

(51) Int. Cl. H04R 9/06; H04R 1/02

(52) U.S. Cl. 381/333; 381/388; 381/334

(57) ABSTRACT

A multi-media loudspeaker which includes a primary loudspeaker case connected with a transmission cable, a loudspeaker, a microphone, a headphone socket, and a volume control, a secondary loudspeaker case connected with the primary loudspeaker case via a cord, a retractable coiling cord device connected with the cord, the retractable coiling cord device comprising a front cover, a spiral spring, a sliding disc, a retraction cord, a positioning bead and a rear cover, and a cable reel connected with the transmission cable, the cable reel comprising an upper cover, a pad, a reeling disc, a spring, and a lower cover, whereby the multi-media loudspeaker can be used for converting electrical signals into sounds loud enough to be heard at a distance and converting sound waves into electrical energy thereby enabling the user to listen to the music and talk through the computer via the Internet.

### BACKGROUND OF THE INVENTION

1. Field of the invention

This invention is related to a multi-media loudspeaker, and in particular to one which can be used for converting electrical signals into sounds loud enough to be heard at a distance and converting sound waves into electrical energy thereby enabling the user to listen to the music and talk through the computer via the Internet.

2. Description of the Prior Art

A loudspeaker is an electro-acoustic transducer that converts electrical signals into sounds loud enough to be heard at a distance. In order to convert electrical energy into sound, a combination of a diaphragm and a compression driver must be coupled to the core of a horn. The compression driver generally has a phasing plug made of ferromagnetic material formed with a plurality of bores between the rear side and the front side of the phasing plug. The coil is wrapped around the exterior side of a cylindrically shaped forming member. The combination of the forming member and coil are then disposed within an annular magnetic gap enabling free vibration in a direction along the longitudinal axis of the forming member. The vibration will cause a corresponding vibration of the diaphragm to produce sound. The suspension has to be flexible in order to accommodate the excursion of the cone or diaphragm. Meanwhile, the suspension has to keep the cone or diaphragm from tipping or becoming“de-centered.” To suspend the diaphragm adjacent to the rear side of the compression driver, the outer perimeter of the diaphragm must be coupled to a suspension, which will in turn be attached to a mounting plate. With the configurations that have been used in the past, the outer surface of the voice coil is substantially exposed and not insulated. A static magnetic field, usually produced by a permanent magnet, is applied so that an alternating signal current flowing through the voice coil causes it to vibrate along its cylindrical axis. This in turn causes the diaphragm to vibrate along the axis of the plurality of bores and generate sound waves corresponding to the signal current. The sound waves are directed through the bores toward the front side, which then radiates the sound waves into the air through the horn. However, none of the conventional loudspeakers can be used for talking over the Internet.

Therefore, it is an object of the present invention to provide a multi-media which can be used for converting electrical signals into sounds loud enough to be heard at a distance and converting sound waves into electrical energy thereby enabling the user to listen to the music and talk through the computer via the Internet.

### SUMMARY OF THE INVENTION

According to the present invention, there is provided a multi-media loudspeaker which includes a primary loudspeaker case connected with a transmission cable, a loudspeaker, a microphone, a headphone socket, and a volume control, a secondary loudspeaker case connected with the primary loudspeaker case via a cord, a retractable coiling cord device connected with the cord, the retractable coiling cord device comprising a front cover, a spiral spring, a sliding disc, a retraction cord, a positioning bead and a rear cover, and a cable reel connected with the transmission cable, the cable reel comprising an upper cover, a pad, a reeling disc, a spring, and a lower cover, whereby the multi-media loudspeaker can be used for converting electrical signals into sounds loud enough to be heard at a distance and converting sound waves into electrical energy thereby enabling the user to listen to the music and talk through the computer via the Internet.

It is the primary object of the present invention to provide a multi-media loudspeaker which can be used for converting electrical signals into sounds loud enough to be heard at a distance.

It is another object of the present invention to provide a multi-media loudspeaker which can be used for converting sound waves into electrical energy.

It is a further object of the present invention to provide a multi-media loudspeaker which enables a user to listen to the music and talk through the computer via the Internet.

The foregoing objects and summary provides only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a multi-media loudspeaker according to the present invention;

FIG. 2 illustrates the interior structure of the secondary loudspeaker according to the present invention;

FIG. 3 illustrates the interior structure of the primary loudspeaker according to the present invention;

FIG. 4 is a plan view of a transmission cable according to the present invention;

FIG. 5 is an exploded perspective view of the coiling retractable cord of the present invention;

FIG. 6 is a perspective view of the sliding disc of the coiling retractable cord of the present invention;

FIG. 7 is a sectional view of the coiling retractable coiling cord of the present invention;

FIG. 8 is an exploded view of the cable reel according to the present invention;

FIG. 9 is an exploded view of the positioning shaft of the cable reel;

FIG. 10 is a schematic view of the positioning shaft of the cable reel; and

FIG. 11 is a sectional view of the positioning shaft of the cable reel.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

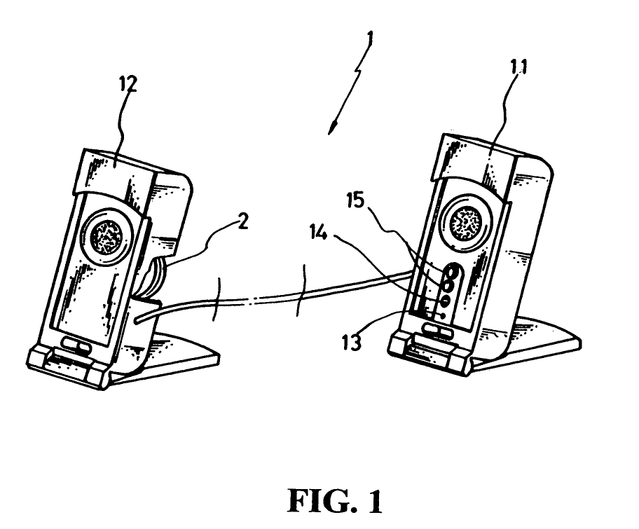

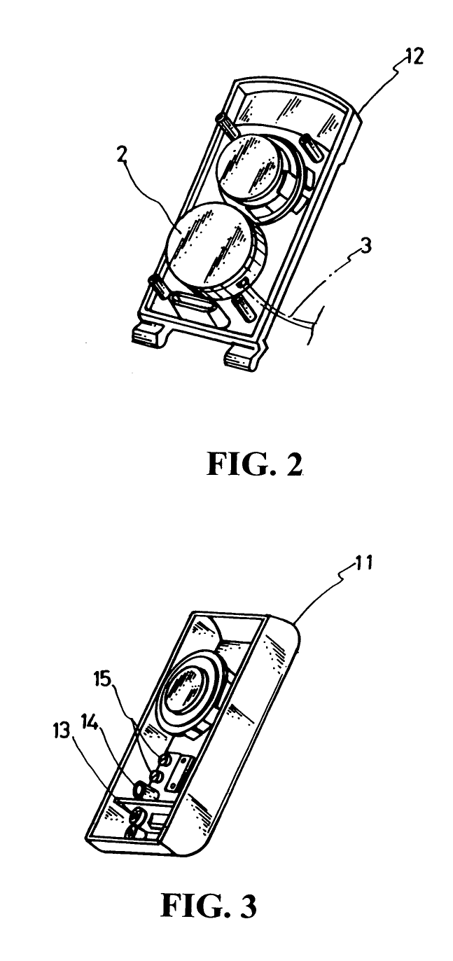

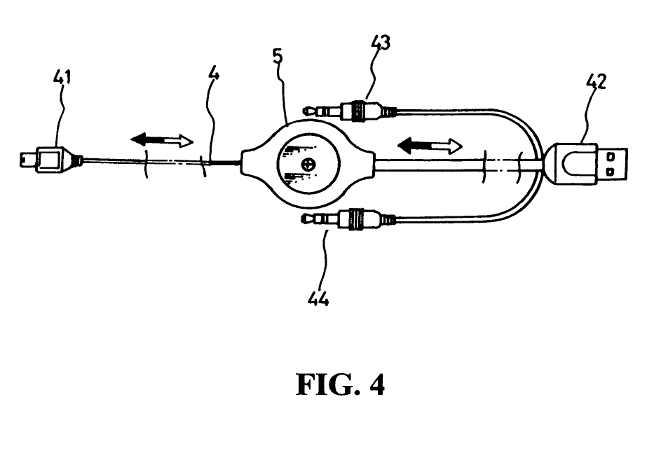

Referring to FIGS. 1, 2 and 3, the multi-media loudspeaker according to the present invention comprises: a primary loudspeaker case 11, a secondary loudspeaker case 12, and an electrical cord 3 connecting the primary loudspeaker case 11 to the secondary loudspeaker case 12. The primary loudspeaker case 11 is connected to a computer via a transmission cable 4. The interior of the primary loudspeaker case 11 is provided with a loudspeaker, a microphone 13 and a headphone socket 14. A volume control 15 is mounted on the primary loudspeaker case 11 for regulating the sound magnitude. As shown in FIG. 2, the interior of the secondary loudspeaker case 12 is provided with a loudspeaker and a retractable coiling cord device 2 which is connected with the electrical cord 3 so that the electrical cord 3 between the primary and secondary loudspeaker cases 11 and 12 can be extended or retracted as required.

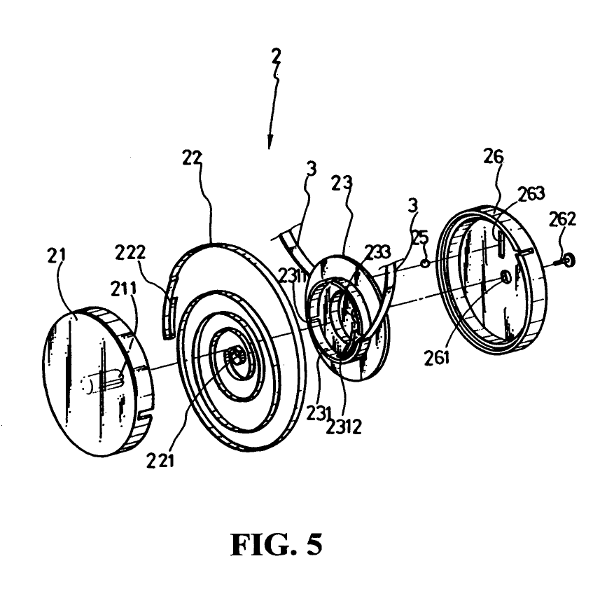

As shown in FIG. 5, the retractable coiling cord device 2 comprises a front cover 21, a spiral spring 22, a sliding disc 23, a cord 3, a positioning bead 25 and a rear cover 26. The spiral spring 22 is inserted within the front direction edge seat 231 of the sliding disc 23 and has a center end 221 in engagement with the center shaft 211 of the inner edge of the front cover 21. The external edge end of the spiral spring 22 is provided with a bending section 222 to be inserted into the edge slit 2311 at the edge seat 231 of the sliding disc 23 and is engaged at the circumferential wall of the edge seat 231 such that the spiral spring 22 is restricted between the front cover 21 and the sliding disc 23 with respect to the center end 221 and the bending section 222 at the external edge end. Thus, the automatic rotation in a front direction or a rear direction, the spiral spring 22 is always at a taut situation.

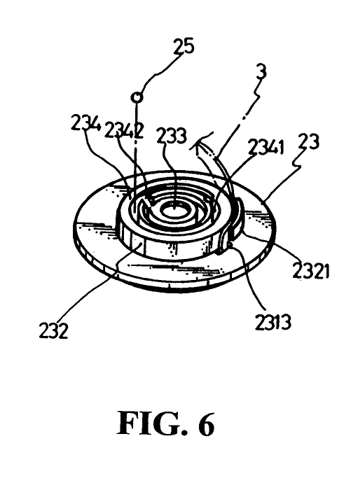

Referring to FIG. 6, the sliding disc 23 has a front direction edge seat 231 and a rear direction edge seat 232, and the front direction edge seat 231 has a through hole 2313 provided on a blocking plate 2312 to allow the cord 3 to pass to the rear direction face and the cord 3 is formed into a front direction retraction cord and rear direction retraction cord with different face. The retraction cord 3 is rolled at the external edge at the front direction edge seat 231 and the rear direction edge seat 232.

The front direction retraction cord 3 and the rear direction retraction cord 3 are of same cord and are of equal length. The retraction cord 3 uses the clip plate 2321 to secure the rear direction retraction cord 3 such that the front direction retraction cord 3 will not enter into the range of the rear direction retraction cord 3 due to pulling force and the rear direction retraction cord 3 will not enter the range of the front direction retraction cord 3. In other words, the lengths for both the cord are always equal. Accordingly, when the front direction retraction cord 3 is pulled, its rear direction retraction cord 3 is retracted. When the front direction retraction cord 3 is at the restored position and the rear direction retraction cord 3 is at a coiled position. The front direction retraction cord 3 and the rear direction retraction cord 3 are of equal length and are of corresponding movement. Thus, when the retraction cord 3 is pulled, the retraction cord 3 at other direction will not be affected and when the cord 3 is positioned at the final position, it will be secured by the clip plate 2321. Thus, the front direction retraction cord 3 is connected with the secondary loudspeaker case 12, while the rear direction retraction cord 3 is connected with the primary loudspeaker case 11.

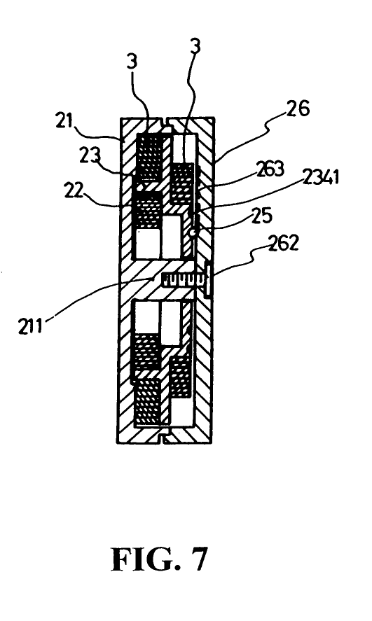

Referring to FIGS. 5 and 7, the front cover 21 has a center shaft 211 at the inner edge to pivotally mount to the center hole 233 of the sliding disc 23. A screw nut 262 passing through the center hole 261 of the rear cover 26 is used for locking so that the sliding disc 23 is restricted between the front cover 21 and the rear cover 26 to form a self rotatable mechanism. Thus, when the front direction retractable cord 3 is pulled, which is equivalent to rotating the sliding disc 23 and when the front direction retractable cord 3 is restored to its original position, the sliding disc 23, due to the rear direction rotation of the spiral spring 22 will pull out the retraction cord 2. In addition, there is a positioning slot 2341 on the rear direction seat 234 of the sliding disc 23 and the railing slot 2341 is provided with a limiting end 2342, and the positioning bead 25 is positioned at the corresponding limiting slot 263 corresponding to the rear cover 26 such that the positioning bead 25 is only positioned at the limiting slot 263 to produce the up and down reciprocation movement. Thus, when the front direction retraction cord 3 pulls the sliding disc 23 to move one round, a positioning mechanism is generated. If the retraction cord 3 is pulled to exceed the second positioning structure, the next positioning is achieved subsequently. Accordingly, the present invention allows multiple stages of positioning when the retraction cord is pulled or retracted.

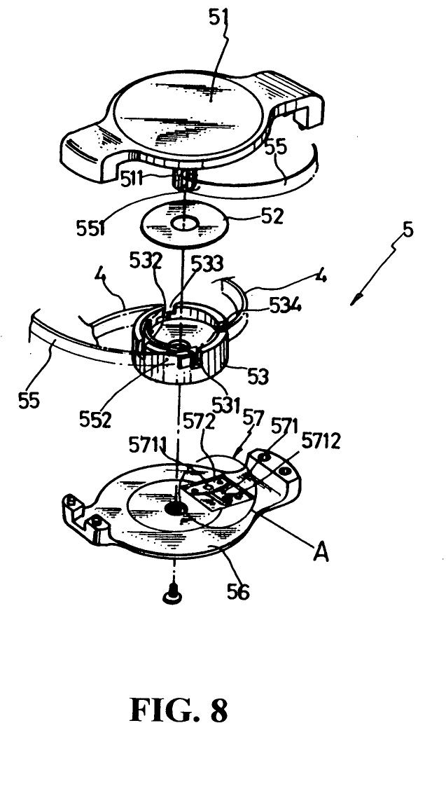

The multi-media loudspeaker 1 is connected with a computer (not shown) via a transmission cable 4 which has a connector 41 at an end and a USB connector 42, a loudspeaker connector 43 and a microphone connector 44 at the other end. As shown in FIG. 8, the transmission 4 may be connected with a cable reel 5 includes an upper cover 51, a pad 52, a reeling disc 53, a transmission cable 4, a spring 55, a lower cover 56, and a positioning element 57. The inner end 551 of the spring 55 is connected to the engaging slot 511 provided at the center shaft of the upper cover 51, and the outer end 551 of the spring 55 is engaged at the engaging slot 531 of the reeling disc 53 with an edge hook. When the reeling disc 53 rotates clockwise or anti-clockwise, the spring 55 becomes either taut or in loosen condition, and the tautening of the spring 55 provides the power for cable restoration of the cable reel 5.

The edge wall of the reeling disc 53 is a clipping plate 532 which can retract one end of the transmission cable 4 out from the clipping hole 533. The other end of the transmission cable 4 is retracted via a corresponding slit 534 so that the transmission cable 4 with equal length surrounds the upper and lower frame position at the outer edge of the reeling disc 53. When the transmission cable 4 is pulled from dual direction, the transmission cable 4 is pulled at the same time with the same speed, and the transmission cable 4 is further pulled, the transmission cable 4 will be restored to its original position.

The reeling disc 53 and the positioning member 57 at the inner edge of the lower cover 56 form an engaging and disengaging mechanism. The positioning member 57 includes a positioning shaft 571 and a positioning plate 572, and the positioning plate 572 covers the top section of the positioning shaft 571, and the two sides thereof is secured with a peg 570. The positioning plate 572 has a center pivot hole 5721 for pivotal mounting of a pivot 5711 on the positioning shaft 571 so that the positioning shaft 571 forms into a pivotal structure with the positioning plate 572. Additionally, the front end of the exposed positioning plate 572 is provided with a sliding protruded section 5712 corresponding to the railing slot 535 at the bottom section of the reeling disc 53.

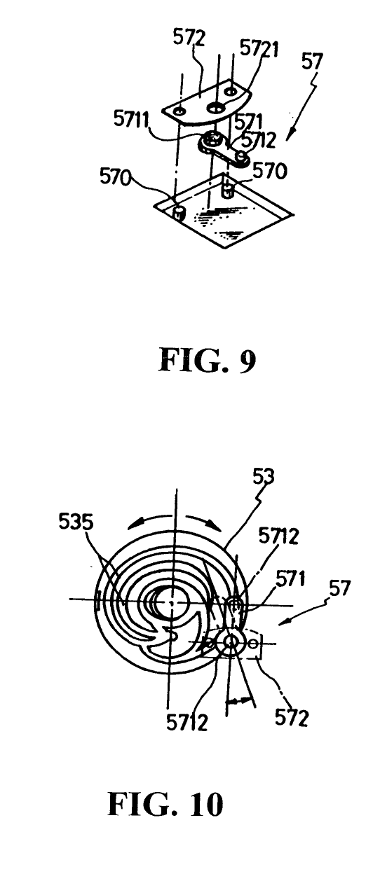

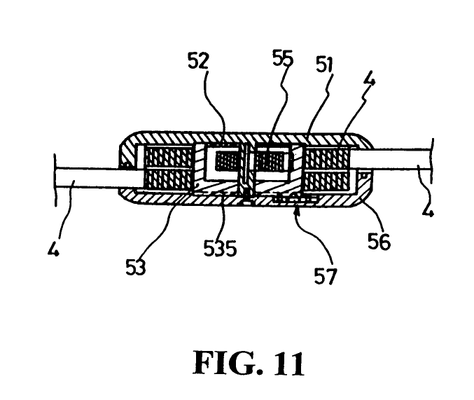

As shown in FIGS. 9, 10 and 11, the bottom section of the reeling disc 53 is provided with an operational railing slot 535 and the positioning shaft 571 provides an alternating engaging and disengaging action based on the rotating of the railing slot 535. Thus, when the transmission cable 4 is pulled, and the reeling disc 53 is rotating, the positioning shaft 571 together with the operational railing slot 535 forms into a swinging action. This swinging operation retracts the transmission cable 4 and then keeps the cable 4 in position. Another retracting of the transmission cable 4 causes the positioning shaft 571 to disengage. Another subsequent positioning is that after the positioning of the cable 4, before the cable 4 has fully retracted, another retraction of the cable 4 will cause the positioning shaft 571 to proceed to an engagement. Accordingly, the positioning shaft of a dual direction cable reel of the present invention provides a one-time reeling and multiple-stage reeling of cable positioning control.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multi-media loudspeaker comprising:
a primary loudspeaker case connected with a transmission cable, said primary loudspeaker case including a loudspeaker, a microphone, a headphone socket, and a volume control;
a secondary loudspeaker case connected with said primary loudspeaker case via a cord, said second loudspeaker including a loudspeaker;
a retractable coiling cord device connected with said cord, said retractable coiling cord device comprising a front cover, a spiral spring, a sliding disc, a retraction cord, a positioning bead and a rear cover, characterized in that the front cover having an inner edge with a center shaft for engaging the center end of the spiral spring is mounted with the rear cover using a screw nut via a center hole of the sliding disc; the spiral spring is positioned within a front edge seat of the sliding disc and has a center end to engage with a center shaft of the front cover and a bending section at the outer edge end of the spiral spring is positioned at a circumferential wall of the front edge seat so that the spiral spring is restricted between the front cover and the sliding disc; the sliding disc has with a center hole and a disc body has a front edge seat and a rear edge seat and the front edge seat uses a through hole provided on a blocking plate to lead the retraction cord to the rear edge seat so that the retraction cord is formed into a front direction retraction cord and a rear direction cord and the external edge of the rear edge seat is provided with a clip plate, and the rear edge seat is provided with a limiting end with a positioning slot and a railing slot for the positioning of the positioning bead; the retraction cord is being retracted via the through hole of the sliding disc to the rear edge seat such that the retraction cord is formed into the front direction cord and the rear direction cord and is secured at the middle position by the clip plate provided at the outer edge of the rear edge seat; the positioning bead is positioned at the limiting slot of the rear cover and the limiting end at the positioning slot and the railing slot; the rear end is locked to the front cover by a screw nut and the inner face of the rear cover is provided with the limiting slot for positioning the positioning bead to reciprocate up and down; the positioning slot on the sliding disc and the limiting end of the railing slot produce one positioning mechanism when the retraction cord rotates one round; the retraction cord is divided into a front direction retraction cord and a rear direction retraction cord; a front direction retraction cord end is a conductive end or a transmission end, and a rear direction retraction cord end is connected to the interior of an object; and
a cable reel connected with said transmission cable, said cable reel comprising an upper cover, a pad, a reeling disc, a spring, and a lower cover, said reeling disc and a positioning element being mounted at an inner edge of said lower cover to form an engaging and disengaging mechanism, wherein said positioning element includes a positioning shaft and a positioning plate and said positioning plate covers a top portion of said positioning shaft and is secured with a peg and said positioning plate has a pivot hole at a center thereof for a pivot mounting of said positioning shaft, and a front end of said positioning plate exposed from a shaft body of a positioning shaft is provided with a sliding protruded section corresponding to a railing slot at a bottom section of said reeling disc, and a bottom section is provided with a railing slot for said sliding protruded section to rotate along said reeling slot so as to provide an alternating engaging and a disengaging action.
